(19) United States
(12) Patent Application Publication
(10) Pub. No.: US 2025/0385343 A1
(43) Pub. Date: Dec. 18, 2025

(54) BATTERY PACK THERMAL INSULATOR

(71) Applicant: SYSTEMS PROTECTION GROUP US LLC, Northville, MI (US)

(72) Inventors: DANIEL A. ROWCOTSKY, DRESHER, PA (US); JIMMY E. TEAL, MOHNTON, PA (US); ALEXA BRADY, ARDMORE, PA (US)

(21) Appl. No.: 19/240,330

(22) Filed: Jun. 17, 2025

Related U.S. Application Data
(60) Provisional application No. 63/661,467, filed on Jun. 18, 2024.

(51) Int. Cl. H01M 10/658; B32B 5/02; B32B 27/12; B60L 50/64; H01M 10/625; H01M 50/24; H01M 50/249; H01M 50/293

(52) U.S. Cl. CPC H01M 10/658; B32B 5/022; B32B 27/12; B60L 50/64; H01M 10/625; H01M 50/24; H01M 50/249; H01M 50/293; B32B 2262/101; B32B 2307/304; B32B 2307/718; B32B 2307/7376; B32B 2457/10; H01M 2220/20

(57) ABSTRACT

A thermal insulator for a battery module including at least one nonwoven layer of intertwined fibers and an outer heat-shrunk polymeric layer, wherein the at least one nonwoven layer of intertwined fibers is compressed by the outer heat-shrunk layer.

### CROSS-REFERENCE TO RELATED APPLICATIONS

This application claims the benefit of U.S. Provisional Application Ser. No. 63/661,467, filed Jun. 18, 2024, which is incorporated herein by reference in its entirety.

### BACKGROUND OF THE INVENTION

### 1. Technical Field

This invention relates generally to thermal insulators, and more particularly to thermal insulators for inhibiting flame propagation between cells and from cells of a battery pack of an electric vehicle.

### 2. Related Art

It is known to contain or shield battery packs, including those used in electric vehicle applications, in thermal insulation. A common material used to form such thermal insulation is a fiberglass fabric. Although the fiberglass fabric insulation provides an acceptable level of protection against contamination and environmental temperatures during normal running conditions, the fiberglass fabric insulation, as used by itself, does not provide a desired level of protection against extreme heat and/or flame propagation, such as may be experienced in a thermal runaway condition of one or more cells of the electric vehicle battery pack. Further, disposing the fiberglass fabric insulation between cells or cell modules in complicated, in particular due to the relatively high surface friction of the fiberglass fabric insulation. As shown in FIGS. 2A-2C, a battery pack 12 and housing 14 thereof are shown having a fiberglass fabric insulator between the cells and about the array of cells, also referred to as cell modules 16, of the battery pack 12. The fiberglass fabric insulator can result in a thermal runaway condition originating in any one cells of the cell modules 16 of the battery pack 12, such that heat and flame propagates from a cell and a single cell module 16 (FIG. 2A) to multiple cell modules (FIG. 2C) adjacent the source of initial flame, in less than 5 minutes at a temperature of 1000° C.

It is desired to provide a thermal insulation that inhibits the propagation of flame between cells with a cell module and between cell modules of a battery pack for 5 minutes or more at a temperature of 1000° C.-1200° C.

### SUMMARY OF THE INVENTION

It is an object of the present disclosure to provide a thermal insulator for use with an electric vehicle battery pack that addresses at least the desire to inhibit the propagation of flame from the battery pack for 5 minutes or more at a temperature of 1000-1200° C.

It is a further object of the present disclosure to provide a thermal insulator for use with an electric vehicle battery pack that minimizes the amount of flame fuel present between cells and between cell modules, thereby inhibiting the propagation of flame between cells and between cell modules of the battery pack.

It is a further object of the present disclosure to provide a thermal insulator for use with an electric vehicle battery pack that is flexible, lightweight, has a thin, low profile to minimize the amount of space occupied by the thermal insulator, is economical in manufacture and easy to assemble between cells of a cell module.

One aspect of the invention provides a thermal insulator for a battery module including at least one nonwoven layer of intertwined fibers and an outer heat-shrunk polymeric layer, wherein the at least one nonwoven layer of intertwined fibers is compressed by the outer heat-shrunk layer.

In accordance with another aspect of the disclosure, the at least one nonwoven layer of intertwined fibers has a mass between about 2500-8000 gsm.

In accordance with another aspect of the disclosure, the at least one nonwoven layer of intertwined fibers is a single nonwoven layer of intertwined fibers having a mass between about 2500-4000 gsm.

In accordance with another aspect of the disclosure, the at least one nonwoven layer of intertwined fibers has a thickness between 15-30 mm.

In accordance with another aspect of the disclosure, the intertwined fibers include a plurality of fibers each having a diameter between 6-13 μm.

In accordance with another aspect of the disclosure, about 90 percent of the plurality of fibers have a length between 50-100 mm.

In accordance with another aspect of the disclosure, the intertwined fibers provide the at least one nonwoven layer having over 50% SiO2 material content by total weight, over 15% CaO material content by total weight, and over 10% Al2O3 material content by total weight.

In accordance with another aspect of the disclosure, the at least one nonwoven layer includes a plurality of nonwoven layers.

In accordance with another aspect of the disclosure, the plurality of nonwoven layers are bonded together.

In accordance with another aspect of the disclosure, the outer heat-shrunk polymeric layer has a thickness between 0.011-0.017 mm.

In accordance with another aspect of the disclosure, the outer heat-shrunk polymeric layer has a kinetic coefficient of friction of about 0.1.

In accordance with another aspect of the disclosure, a thermal insulator for a battery module consists of: at least one nonwoven layer, and an outer heat-shrunk polymeric layer, wherein the at least one nonwoven layer is encapsulated by the outer heat-shrunk layer.

In accordance with another aspect of the disclosure, an electric vehicle battery pack is provided. The battery pack has a housing and a plurality of cell modules bounded by the housing. The cell modules are spaced from one another by a gap, and a thermal insulator, including a nonwoven layer and an outer heat-shrunk polymeric layer encapsulating the nonwoven layer, is compressed within the gap.

### BRIEF DESCRIPTION OF THE DRAWINGS

These and other aspects, features and advantages will become readily apparent to those skilled in the art in view of the following detailed description of presently preferred embodiments and best mode, appended claims, and accompanying drawings, in which:

FIG. 1 is a schematic perspective view of an electric motor vehicle having a battery pack with a thermal insulator constructed in accordance with an aspect of the invention;

FIGS. 2A-2C illustrate a schematic representation of an electric vehicle battery pack in accordance with prior art, not having a thermal insulator in accordance with the disclosure, undergoing a thermal runaway condition with a flame propagating from a location of flame initiation (FIG. 2A) throughout a plurality of cells of the battery pack (FIG. 2C);

FIGS. 3A-3C are views similar to FIGS. 2A-2C, with the electric vehicle battery pack including the thermal insulator constructed in accordance with an aspect of the disclosure, with the thermal insulator shown suppressing and inhibiting flame propagating from a location of a thermal runaway condition within a cell (FIG. 3A) throughout the plurality of cells of the battery pack (FIG. 3C);

FIG. 4 is a schematic side view of a thermal insulator in accordance with a non-limiting embodiment of the disclosure;

FIG. 5 is a schematic cross-sectional view taken generally along the line 5-5 of FIG. 4; and

FIG. 6 is a view similar to FIG. 5 illustrating a thermal insulator in accordance with another non-limiting embodiment of the disclosure.

### DETAILED DESCRIPTION OF PREFERRED EMBODIMENTS

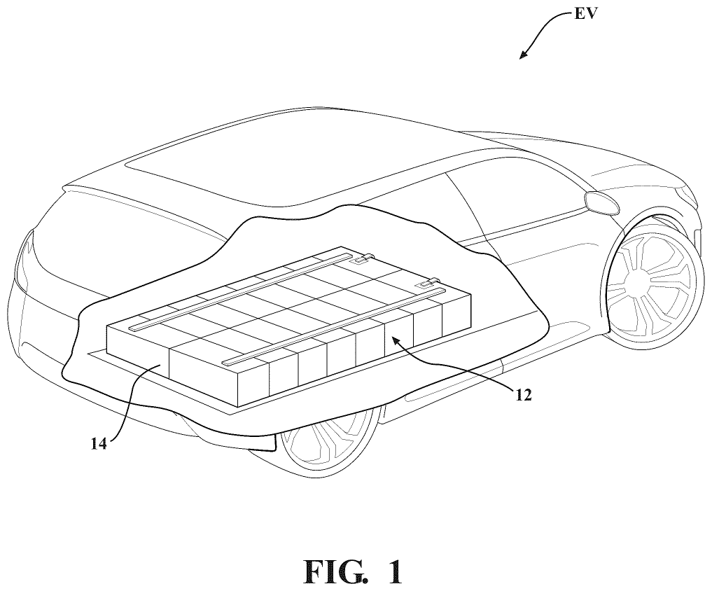

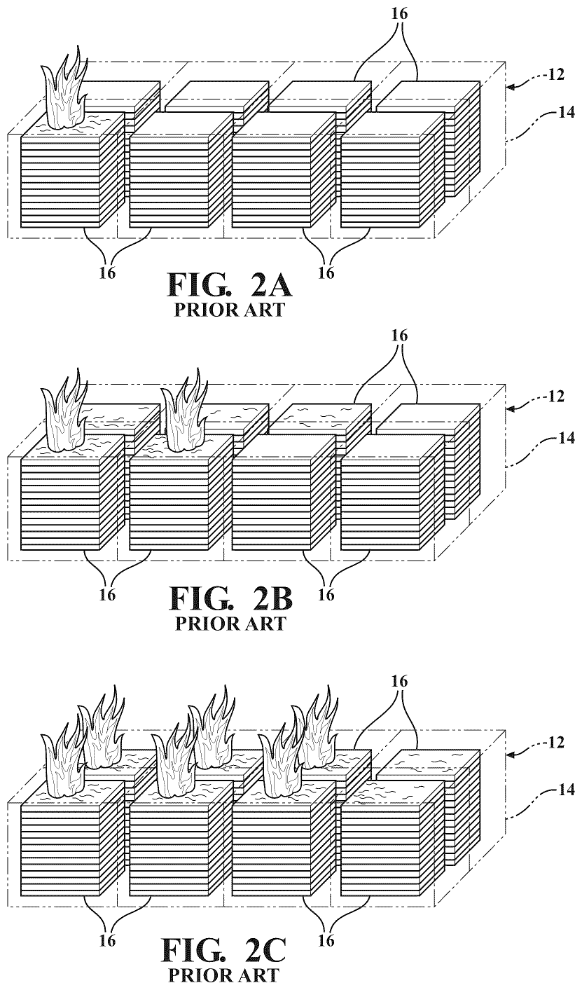

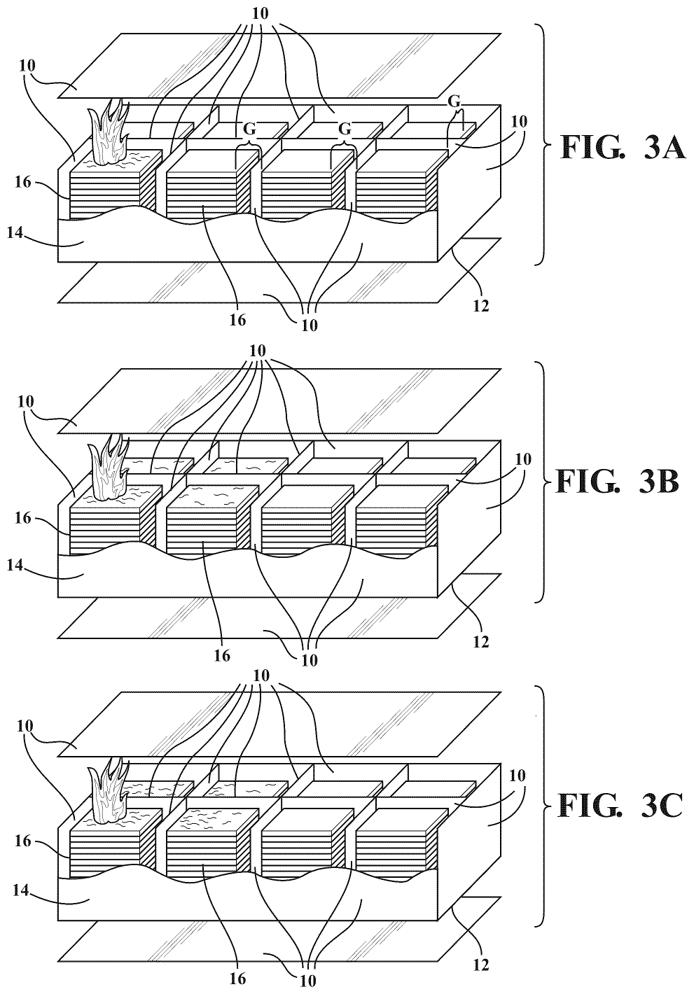

Referring in more detail to the drawings, FIG. 1 illustrates a motor vehicle, shown as an electrically powered motor vehicle, also referred to as electric vehicle EV, having a battery module, also referred to as battery pack 12, such as a lithium-ion battery pack, by way of example and without limitation, configured with a thermal insulator 10 in accordance with an aspect of the invention. The electric vehicle battery pack 12 includes a housing member, also referred to as casing or housing 14, bounding a plurality of cells, wherein separate clusters of the cells form separate cell modules 16 spaced from one another by gaps G (FIG. 3A), and including bus-bars electrically interconnecting separate cell modules 16 with one another, and high voltage electrical connectors, cell interfaces, low voltage signal wires, high voltage cables and a cooling system having cooling tubes through which coolant can flow, as is generally known in electric vehicle battery packs. During normal use, wherein the electric vehicle EV is driven in normal fashion, as intended, and including in non-normal situations, such as in a vehicle crash condition or some other condition causing an impact force to battery pack 12, in contrast to a battery pack 12 not having a thermal insulator 10 as disclosed herein, thereby resulting in potential flame propagation, as shown in FIGS. 2A-2C, a thermal runaway condition originating in any one of the separate cell modules 16 of battery pack 12, with the thermal insulator 10 being disposed within the gaps G and/or about the cell modules 16, is controlled and contained via the thermal insulator 10, as illustrated schematically in FIGS. 3A-3C. As such, flame propagation is prevented by the thermal insulator 10 for at least 5 minutes at an internal cell temperature ranging between 1000-1200° C., and an outer surface temperature of a backplate of the battery housing 14, also referred to as case, is maintained to be less than 100° C. for 5 minutes or more.

As shown schematically in FIGS. 3A-3C, the thermal insulator(s) 10, which can be arranged to thermally isolate the cell modules 16 from one another by being disposed with gaps G between the cell modules 16, as well as to shield and protect surfaces of the battery pack housing 14 and members of the battery pack 12, against extreme temperature thermal runaway conditions and contamination, such as from fluid or debris, as well as from impact forces, such as may be experienced in a crash condition, includes a relatively thin, flexible wall 18, such as having a total thickness (t) (FIG. 5). The relaxed thickness t is greater than the width of the gap G, such that the thickness t is compressed from a relaxed stated to a compressed thickness state, corresponding to the width of the gap G, upon being disposed within the gap G between the cell modules 16. The gap G can be provided having any desired width suitable for the battery application, with the thickness t of the wall 18 being provided accordingly to ensure a compressed, interference fit of the insulator 10 within the gap G. The wall 18 of the thermal insulator 10 provides a protective outer barrier about an outer periphery of the cell modules 16, as well as providing a protective thermal, fire resistant barrier between adjacent cells 16 by being disposed within gaps G to effectively thermally isolate each cell module 16 from an adjacent cell module 16.

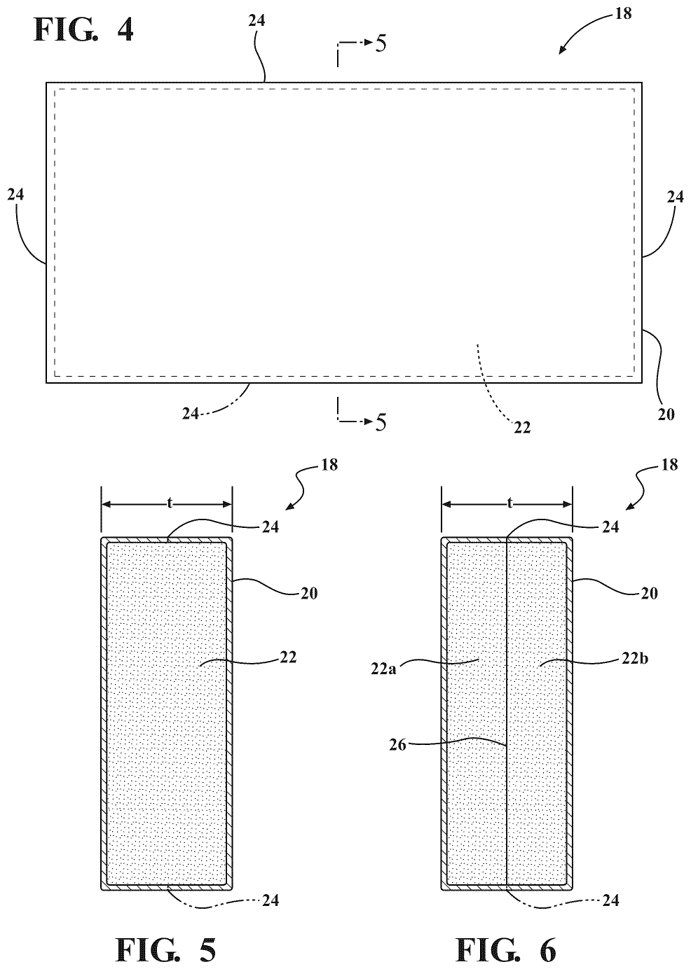

The wall 18, in the non-limiting embodiment illustrated, as best shown in FIGS. 4 and 5, is shown including a heat-shrunk polymeric outer layer 20, having a gauge between about 45-90, and a mechanically bonded nonwoven mineral material 22, such as via being needled punched, as discussed further below. The nonwoven material 22, also referred to as nonwoven layer 22, has a thickness, while in a free, uncompressed state, also referred to as relaxed state, that is greater than the width (corresponding to the direction of the thickness of the nonwoven layer 22) of the gap G, such as being greater in thickness than the width of the gap G by at least 1 mm, and preferably between about lmm-6 mm. Accordingly, the increased thickness of the nonwoven material 22 relative to the width of gap G necessitates a tight, interference fit, also referred to as compression fit, of the wall 18 within the gap G, such that upon being disposed within the gap G, the wall 18 is elastically compressed to the width of the gap G. The thickness t of the thermal insulator 10 is provided essentially (intended to mean substantially, which means nearly entirely but not entirely, such as greater than 98%, and in an exemplary embodiment greater than 99%) by the thickness of the nonwoven layer 22, with the thickness of the non-woven layer 22 being between about 15-30 mm, and with the thickness of the heat-shrunk polymeric outer layer 20 being between about 0.017 mm-0.011 mm. Accordingly, the thickness of the heat-shrunk polymeric outer layer 20 contributes minimally to the total thickness t of the thermal insulator 10. The compression fit, in addition to enhancing the thermal insulation properties, aids in fixing the thermal insulator 10 in its desired location between the cell modules 16, thereby negating the need for secondary fixation mechanisms, e.g. outwardly facing adhesives, to maintain the insulator 10 in position during handling and assembly. In one embodiment according to the disclosure, the thickness t of the wall 18 is between about 24 mm-30 mm, by way of example and without limitation.

The nonwoven layer 22 is fully encapsulated by the outer heat-shrunk polymeric layer 20. The nonwoven material 22 can include various grades of fiberglass/e-glass, silica, nomex, basalt, ceramic, etc, by way of example and without limitation, and can be cut to any desired shape, including symmetrical or non-symmetrical shapes. Regardless of the material selected, the nonwoven material 22 has a mass, expressed in grams-per-square meter (g/m², also represented as gsm), between about 2500 gsm-8000 gsm, and most preferably between 2500 gsm-5000 gsm, which can be selected based at least in part on the thickness of the gap G to provide the desired compression fit and thermal, heat-resistance properties, which is enhanced by compression imparted by the heat-shrunk outer layer 20. In accordance with an exemplary embodiment, the nonwoven layer 22 needle punched, carded, and cross-lapped in a single pass operation. The nonwoven layer 22 is made of a plurality of fibers intertwined with one another, with the individual fibers having a diameter between 6 μm-13 μm and having a typical length (typical meaning about 90% of the fibers) between 50 mm-100 mm, with about 5% of the fibers having a length less than 25 mm, due to fracture, and about 5% of the fibers having a length greater than 100 mm, with no submicron particles present. The material composition of the fibers includes, by weight percent (wt %) of the total weight of the nonwoven layer 22, over 50 wt % SiO₂, and in an exemplary embodiment between 52-56 wt % SiO₂, over 15 wt % CaO, and in an exemplary embodiment between 16-25 wt % CaO, over 10 wt % Al₂O₃, and in an exemplary embodiment between 12-16 wt % Al₂O₃, over 5 wt % B₂O₃, and in an exemplary embodiment between 5-10 wt % B₂O₃, between 0-5 wt % MgO, between 0-1 wt % F₂, between 0-2 wt % Na₂O+K₂O, 0.05-0.4% Fe₂O₃, and between 0-0.8 wt % TiO₂. The exemplary embodiment was made having a target gsm of 3600, with a range of 2500 gsm-4000 gsm and more preferably between 3200 gsm-4000 gsm, and having a tensile strength in a machine direction between about 20 N/25 mm-30 N/25 mm and in a cross direction between about 90 N/25 mm-110 N/25 mm. The nonwoven layer 22 can be provided as a single, monolithic piece of material 22, or as a plurality of nonwoven layers 22a, 22b (FIG. 6) stacked together and encapsulated by the heat-shrunk outer layer 20, and shown as a pair of nonwoven layers 22a, 22b, by way of example and without limitation. The heat-shrunk outer layer 20 can facilitate holding the multiple nonwoven layers 22a, 22b in tightly sandwiched relation with one another without need of fixing the nonwoven layers 22a, 22b to one another prior to encapsulating the nonwoven layers 22a, 22b with the heat-shrinkable outer layer 20 and then shrinking the heat-shrinkable outer layer 20. However, to facilitate handling, the multiple nonwoven layers 22a, 22b can be initially fixed together by selectively located applications of a suitable adhesive 26, such as an acrylic adhesive, and in one exemplary embodiment, a polyolefin pressure sensitive adhesive (PSA), such as at discrete locations spaced from one another, such as at corners or along peripherally extending edges of the nonwoven layers 22a, 22b, by way of example and without limitation, thereby fixing the nonwoven layers 22a, 22b together until the outer layer 20 is shrunken about the nonwoven layers 22a, 22b. Of course, the PSA 26 can be applied to an entire face of one or more of the nonwoven layers 22a, 22b, as desired, thereby forming a continuous, uninterrupted layer of the PSA 26 sandwiched between the nonwoven layers 22a, 22b.

The heat-shrunk outer layer 20 can be provided as a film of a variety of heat-shrinkable polymeric materials, including polyethylene, polyolefin, PVC, polypropylene, and polyester, by way of example and without limitation. In the exemplary embodiment, the heat-shrunk outer layer 20 was provided as polyethylene, and to optimize performance, having a mass (g/m²) between about 11-17 g/m², a thickness between about 0.011-0.017 mm, an elongation of about 120-130%, a tensile strength of about 5-10 N/mm², a kinetic coefficient of friction of about 0.1, and a free shrinkage @102° C. of about 65% of its area. The heat-shrunk outer layer 20 facilitates assembly within the gap G by providing a reduced kinetic coefficient of friction surface relative to the kinetic coefficient of friction of the outer surface of the nonwoven layer 22, thereby improving assembly efficiency, in addition to preventing unwanted buckling or bunching of the nonwoven layer 22 as it is being inserted into the gap G during assembly, in addition to enhancing the thermal properties of the thermal insulator 10. The heat-shrunk outer layer 20 can be disposed about the nonwoven layer 22 in a variety of manners, and then heat-shrunk into tight compression with the nonwoven layer 22. For example, the heat-shrunk outer layer 20 can be provided as a single, monolithic piece of material that is folded about the nonwoven layer 22 and then adhered to itself via a heat-cutting operation, thereby forming a single, continuous heat-staked seam 24 along the length and along the opposite ends of the thermal insulator 10 (FIG. 4 designates this seam 24 with the solid lead lines). It is contemplate that the outer layer 20 can include other arrangements of seams, and further could be provided a pair of heat-shrinkable sheets laid over opposite sides of the nonwoven layer 22, followed by a heat-staking operation about the entire outer periphery of the nonwoven layer 22 to heat-bond the opposite layers to one another via an annular heat-bonded seam (FIG. 4 designates this seam 24 with the solid lead lines and a phantom lead line), and then following the encapsulation of the nonwoven layer 22 with the heat-shrinkable outer layer 20 with a heat-shrinking operation to bring the outer layer 20 into its heat-shrunk, tight fit about the nonwoven layer 22. Regardless, the outer layer 20 fully encapsulates the nonwoven layer 22 and is heat-shrunk into a snug, tight compression fit about the nonwoven layer 22.

Obviously, many modifications and variations of the present invention are possible in light of the above teachings. It is contemplated that all features of all claims and of all embodiments can be combined with each other, so long as such combinations would not contradict one another. It is, therefore, to be understood that within the scope of the appended claims, the invention may be practiced otherwise than as specifically described.

What is claimed is:

1. A thermal insulator for a battery module, comprising:
at least one nonwoven layer of intertwined fibers; and
an outer heat-shrunk polymeric layer,
wherein the at least one nonwoven layer of intertwined fibers is compressed by the outer heat-shrunk layer.

2. The thermal insulator of claim 1, wherein the at least one nonwoven layer of intertwined fibers has a mass between about 2500-8000 gsm.

3. The thermal insulator of claim 1, wherein the at least one nonwoven layer of intertwined fibers is a single nonwoven layer of intertwined fibers having a mass between about 2500-4000 gsm.

4. The thermal insulator of claim 2, wherein the at least one nonwoven layer of intertwined fibers has a thickness between 15-30 mm.

5. The thermal insulator of claim 4, wherein the intertwined fibers include a plurality of fibers each having a diameter between 6-13 μm.

6. The thermal insulator of claim 5, wherein about 90 percent of the plurality of fibers have a length between 50-100 mm.

7. The thermal insulator of claim 2, wherein the intertwined fibers provide the at least one nonwoven layer having over 50% SiO₂ material content by total weight, over 15% CaO material content by total weight, and over 10% Al₂O₃ material content by total weight.

8. The thermal insulator of claim 2, wherein the at least one nonwoven layer includes a plurality of nonwoven layers.

9. The thermal insulator of claim 8, wherein the plurality of nonwoven layers are bonded together.

10. The thermal insulator of claim 2, wherein the outer heat-shrunk polymeric layer has a thickness between 0.011-0.017 mm.

11. The thermal insulator of claim 2, wherein the outer heat-shrunk polymeric layer has a kinetic coefficient of friction of about 0.1.

12. A thermal insulator for a battery module, consisting of:
at least one nonwoven layer; and
an outer heat-shrunk polymeric layer,
wherein the at least one nonwoven layer is encapsulated by the outer heat-shrunk layer.

13. The thermal insulator of claim 12, wherein the at least one nonwoven layer has a mass between about 2500-8000 gsm.

14. The thermal insulator of claim 13, wherein the at least one nonwoven layer of intertwined fibers has a thickness between 15-30 mm.

15. The thermal insulator of claim 14, wherein the at least one nonwoven layer is fabricated from a plurality of fibers each having a diameter between 6-13 μm.

16. The thermal insulator of claim 15, wherein about 90 percent of the plurality of fibers have a length between 50-100 mm.

17. An electric vehicle battery pack, comprising:
a housing;
a plurality of cell modules bounded by said housing, said cell modules spaced from one another by a gap; and
a thermal insulator including a nonwoven layer and an outer heat-shrunk polymeric layer encapsulating the nonwoven layer,
wherein the thermal insulator is compressed within the gap.

18. The electric vehicle battery pack of claim 17, wherein the nonwoven layer has a mass between about 2500-8000 gsm.

19. The electric vehicle battery pack of claim 18, wherein the nonwoven layer is fabricated from a plurality of fibers, wherein about 90 percent of the plurality of fibers have a length between 50-100 mm.

20. The electric vehicle battery pack of claim 19, wherein each of the plurality of fibers has a diameter between 6-13 μm.
